(19) United States
(12) Patent Application Publication
(10) Pub. No.: US 2003/0167326 A1
(43) Pub. Date: Sep. 4, 2003

(54) Highly redundant, high-reliability and high-performance platform logging/billing generation and collection subsystem

(76) Inventor: Jeremy S. de Bonet, N. Andover, MA (US)

Correspondence Address: GRAY, CARY, WARE & FREIDENRICH LLP, 1221 SOUTH MOPAC EXPRESSWAY, SUITE 400, AUSTIN, TX, 78746-6875, US

(21) Appl. No.: 10/345,880

(22) Filed: Jan. 16, 2003

Related U.S. Application Data
(60) Provisional application No. 60/349,420, filed on Jan. 18, 2002.
(60) Provisional application No. 60/349,424, filed on Jan. 18, 2002.
(60) Provisional application No. 60/349,344, filed on Jan. 18, 2002.

(51) Int. Cl. G06F 15/173; G06F 15/16

(52) U.S. Cl. 709/224; 709/206

(57) ABSTRACT

Systems and methods for selectively distributing logging information for a system to a plurality of clients to achieve improved reliability and performance. One embodiment comprises a system in which a logging subsystem monitors transactions of a transaction system, compares the transactions to criteria specified for one or more clients, and delivers logging information for transactions that meet the specified criteria to the respective clients. In one embodiment, the logging subsystem is implemented in a network proxy server. The logging subsystem is configured to receive subscription information from each client, wherein the subscription information specifies the criteria for selecting logging information to transmit to the corresponding client. The subscription information may also specify the level of detail of the long information to be transmitted to the client.

### CROSS-REFERENCE TO RELATED APPLICATIONS

This application claims priority to U.S. Provisional Patent Application No. 60/349,420, filed Jan. 18, 2002 by Jeremy S. de Bonet, entitled “A Highly Redundant, High-Reliability and High-Performance Platform Logging/Billing Generation and Collection Subsystem, U.S. Provisional Patent Application No. 60/349,424, entitled “Network Proxy Platform that Simultaneously Supports Data Transformation, Storage, and Manipulation for Multiple Protocols”by de Bonet et al., filed on Jan. 18, 2002, U.S. Provisional Patent Application No. 60/349,344 entitled “Modular Plug-In Transaction Processing Architecture” by de Bonet et al., filed Jan. 18, 2002, which are hereby fully incorporated by reference herein.

Additionally, U.S. patent application Ser. No.______, entitled “Method and System of Performing Transactions Using Shared Resources and Different Applications,” by de Bonet et al., filed Jan. 14, 2003 is incorporated by reference herein.” which is incorporated by reference as if set forth herein in its entirety.

### BACKGROUND OF THE INVENTION

1. Technical Field

This invention generally relates to the reporting of log data from computer systems. More particularly, this invention is a method for creating a subsystem, which can be implemented in software or hardware, that enables the selective dissemination of system logs to multiple networked machines.

2. Related Art

In most large systems, there exists the need for a secondary mechanism that can be used to monitor the performance, activity and behavior of the primary function of the system. It is common in the art for the secondary mechanism to use a method called logging.

Generally, the method of logging involves the generation of a series of log messages that correspond to transactions or events that occur in the system. These log messages typically use some sort of formal structure or format in order to facilitate the extraction of information by other systems, but they may be less structured in some systems.

High performance transaction systems generate huge volumes of logging information. Because of the volume of the logging information and the speed with which it is generated, the retrieval of the logging information can greatly tax these systems and limit their overall performance. It is important to be able to retrieve this information, however, because in many applications it is used for such purposes as generating billing information. Consequently, speed and reliability are of the utmost importance.

Because the volume of logging information and the speed with which it is generated are so high in these high performance transaction systems, it can be very difficult to handle this information. More specifically, it is generally very difficult to do anything other than simply dump the logging information to a single output device. As a result, prior art technologies do just that—dump the logging information to a single output device, such as a console display, a text file, a database, or a printer. No filtering, selection, distribution, or other processing of log messages is performed. After the logging information is dumped to the output device, it can be processed further.

This way of handling logging information, however, can be problematic. First, there is the problem of post-processing. Since the logging system simply outputs the logging information, additional systems must be employed to perform the post-processing. These systems must be coordinated with the logging system and possibly with each other in order to achieve redundancy, load-balancing, filtering or other processing of the logging information. Deploying these additional systems requires increased development time, increased hardware resources, and more maintenance personnel.

Another problem is the risk of losing the logging information. Since the information is all dumped to a single location, it may be at risk due to destination device malfunctions, or even bottlenecks in getting the information to the destination device. The problem of bottlenecks is particularly relevant in the context of generating logging information for Web servers, network proxies or the like, as the bandwidth available to transmit the information over the network may be limited.

### SUMMARY OF THE INVENTION

One or more of the problems outlined above may be solved by the various embodiments of the invention. Broadly speaking, the invention comprises systems and methods for selectively distributing logging information for a system to a plurality of clients to achieve improved reliability and performance.

One embodiment of the invention comprises a system in which a logging subsystem monitors transactions of a transaction system, compares the transactions to criteria specified for one or more clients, and delivers logging information for transactions that meet the specified criteria to the respective clients. In one embodiment, the logging subsystem is implemented in a network proxy server. The logging subsystem is configured to receive subscription information from each client, wherein the subscription information specifies the criteria for selecting logging information to transmit to the corresponding client. The subscription information may also specify the level of detail of the long information to be transmitted to the client.

One embodiment of the invention comprises a method in which transactions within a transaction system are monitored, and logging information corresponding to the transactions is selectively distributed to one or more clients. In one embodiment, each loggable transaction is compared to the subscription criteria of each of the clients. For each client, it is determined whether the transaction meets the specified criteria or not. If the criteria are not met, no logging information for the transaction is transmitted to the client. If the criteria are met, logging information is generated for the transaction. The information is generated according to criteria that specify a level of detail desired by the client. The generated logging information is then transmitted to the client. This process is repeated for each client, then the next loggable transaction is processed in the same manner.

In one embodiment, the subscription criteria for a set of clients are identical. As a result, the same logging information is transmitted to each of these clients. The transmission of this redundant information to each of the clients serves to increase their reliability of the system. In another embodiment, the subscription criteria for a set of clients define an exclusive subset of the logging information for each client. In this manner, the system performs load balancing that may improve the performance of the system. In another embodiment, the subscription criteria for the clients serve as filters for the logging information, so that logging information which is unnecessary or undesired is not transmitted to the clients. This reduces the loading on the system, reducing bandwidth requirements and improving performance.

Another embodiment of the invention comprises a software application. The software application is embodied in a computer-readable medium such as a floppy disk, CD-ROM, DVD-ROM, RAM, ROM, database schemas and the like. The computer readable medium contains instructions which are configured to cause a computer such as a network proxy server to execute a method which is generally as described above. It should be noted that the computer readable medium may comprise a RAM or other memory which forms part of a computer system. The computer system would thereby be enabled to perform a method in accordance with the present disclosure and is believed to be within the scope of the appended claims.

Numerous additional embodiments are also possible.

### BRIEF DESCRIPTION OF THE DRAWINGS

Other objects and advantages of the invention may become apparent upon reading the following detailed description and upon reference to the accompanying drawings.

FIG. 1 is a diagram illustrating a network-based system in accordance with one embodiment of the present invention.

FIG. 2 is a diagram illustrating the components of the client and server computers in accordance with one embodiment of the invention.

FIG. 3 is a diagram illustrating the basic architecture of a logging system in accordance with one embodiment of the invention.

FIG. 4 is a top-level flow diagram illustrating a method in accordance with one embodiment of the invention.

FIG. 5 is a flow diagram illustrating a method in accordance with one embodiment of the invention.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as defined by the appended claims.

### DETAILED DESCRIPTION OF A PREFERRED EMBODIMENT

A preferred embodiment of the invention is described below. It should be noted that this and any other embodiments described below are exemplary and are intended to be illustrative of the invention rather than limiting.

Broadly speaking, the invention comprises systems and methods for selectively distributing logging information for a system to a plurality of clients to achieve improved reliability and performance.

In one embodiment, the present invention comprises a system for logging transactions in a network environment. The system includes a transaction system such as a Web server or network proxy and a logging subsystem that is implemented in the transaction system. The logging subsystem is configured to monitor transactions in the system and to distribute logging information (or subsets thereof) to one or more clients that are subscribed to the logging subsystem.

It should be noted that, while the present disclosure describes embodiments of the invention that log transactions in a transaction system such as a Web server or network proxy, alternative embodiments may log events in any type of system in which loggable events occur. Such systems may include virtually any software system, as well as almost any electronically monitorable mechanical system. The term “transaction system” should therefore be broadly construed to include any such system, and the term “transaction should be construed to include any such loggable events.

The logging subsystem distributes the logging information as requested by the subscribing clients. The clients define the type of information that is desired and the manner in which it is reported by the logging subsystem. For example, a client may request only certain types of messages, or it may request a subset of all of the messages. The client may request that the logging subsystem provide log messages which provide little detail about the corresponding transaction, or a large amount of detail.

This system can solve one or more of the problems of prior art systems through the use of appropriate subscriptions to the logging subsystem. For example, redundant storage of logging information may be provided by having two or more clients subscribe to identical sets of logging information. Then, as transactions occur in the system, corresponding log messages are transmitted to each of these clients. Load balancing can be achieved by having each of a plurality of clients subscribe to an exclusive subset of the logging information. For instance, one client may subscribe to the set of all even-numbered log messages, while a second client may subscribe to the set of all odd-numbered log messages. Many other variations are possible.

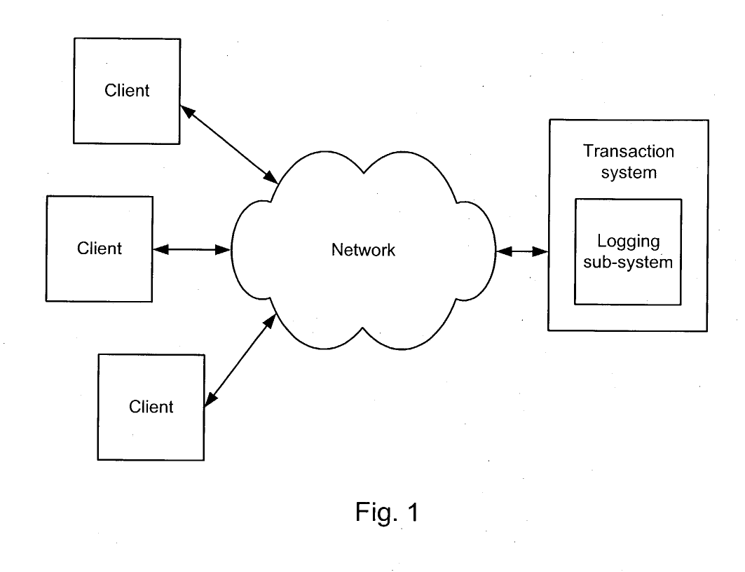

Referring to FIG. 1, a diagram illustrating a network-based system in accordance with one embodiment of the present invention is shown. As depicted in the figure, a transaction system 16 is operated in conjunction with a logging subsystem 18. Transaction system 16 and logging subsystem 18 are coupled to a network 14. A plurality of clients 12 are also coupled to the network. Logging subsystem 18 acts as a server which provides logging information to clients 12. That particular logging information that is provided to each of the clients is determined by subscription criteria that are specified for each of the clients.

It should be noted that, for the purposes of this disclosure, identical items in the figures may be indicated by identical reference numerals followed by a lowercase letter, e.g., 12a, 12b, and so on. The items may be collectively referred to herein simply by the reference numeral.

It should be noted that the network configuration illustrated in FIG. 1 is intended to be exemplary. Other embodiments may use alternative configurations. For example, if transaction system 16 comprises a Web server, it would be coupled to the Internet in order to provide service to Web clients. Clients of the logging subsystem could be directly coupled to the logging subsystem, or they could be coupled to it through a separate network. Again, this is merely an example and is not intended to be limiting.

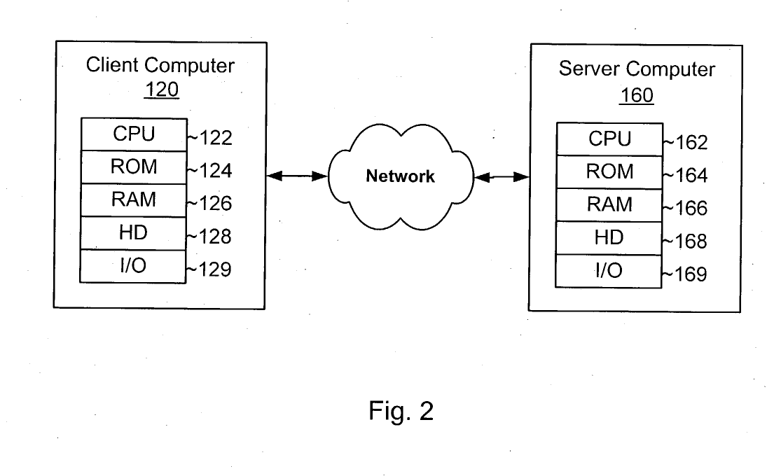

Referring to FIG. 2, a diagram illustrating the components of the client and server computers in accordance with one embodiment is shown. As depicted in the figure, both client computer 20 and server computer 40 are bi-directionally coupled to network 30. Network 30 may be an internal network, or an external network, such as the Internet.

Client computer 20 may comprise a general purpose desktop computer, a laptop computer, or any other device capable of communicating over network 30 and processing (e.g., receiving and displaying) logging information received from server computer 40. Server computer 40 may also be any of a number of suitable computing devices, such as a general purpose desktop computer, a computer specifically designed as a server, and the like.

The client computer 20 can include central processing unit (“CPU”) 22, read-only memory (“ROM”) 24, random access memory (“RAM”) 26, hard disk drive (“HD”) or storage memory 28, and input/output device(s) (“I/O”) 29. I/O 29 can include a keyboard, monitor, printer, electronic pointing device (e.g., mouse, trackball, stylus, etc.), or the like. Similarly, server computer 40 can include CPU 42, ROM 44, RAM 46, HD 48, and I/O 49.

Each of the computers in FIG. 2 may have more than one CPU, ROM, RAM, HD, I/O, or other hardware components. For simplicity, each computer is illustrated as having one of each of the hardware components. It should be noted that FIG. 2 is a simplification of an exemplary hardware configuration. Many other alternative hardware configurations are possible and known to persons of skill in the art.

Each of computers 20 and 40 is an example of a data processing system. ROM 24 and 44, RAM 26 and 46 and hard disk drives 28 and 48 can be replaced with other media that can be read by CPUs 22 or 42. Each of these types of memories is a medium, readable by a data processing system (“computer-readable media”), in which a software application may be embodied. These memories may be internal or external to computers 20 or 40.

Portions of the methods described herein may be implemented in suitable software code that may reside within ROM 24 or 44, RAM 26 or 46, hard disk drives 28 or 48 or other computer-readable media within the system. The software code may also be contained on a separable data storage device, such as a removable hard disk. Alternatively, the instructions may be stored as software code on a removable computer-readable medium such as a DASD array, magnetic tape, floppy diskette, optical storage device, or the like. In one embodiment, the software code may comprise lines of compiled C++, Java, or other language code.

In the hardware configuration above, the various software components may reside on a single computer or on any combination of separate computers. Other configurations may also be used. For example, the functions of any one of the computers may be performed by a different computer than illustrated in FIG. 2. Additionally, a computer program or its software components with such code may be embodied in more than one data processing system readable medium in more than one computer. For simplicity, a single system is shown for each of client computer 20 and server computer 40. In alternative embodiments, some or all of the software components may reside on the same computer. For example, one or more the software component(s) of the server computer 40 could reside on the client computer 20, or vice versa.

Communications between the computers in FIG. 2 can be accomplished using electronic, optical, radio-frequency, or other signals. For example, when a user is at client computer 20, client computer 20 may convert signals received from server computer 40 to a human understandable form and may convert input from a human understandable form to appropriate electronic, optical, radio-frequency, or other signals to be used by server computer 40. Similarly, when an operator is at server computer 40, server computer 40 may convert the signals to a human understandable form when sending a communication to the operator and may convert input from a human understandable form to appropriate electronic, optical, radio-frequency, or other signals to be used by client computer 20.

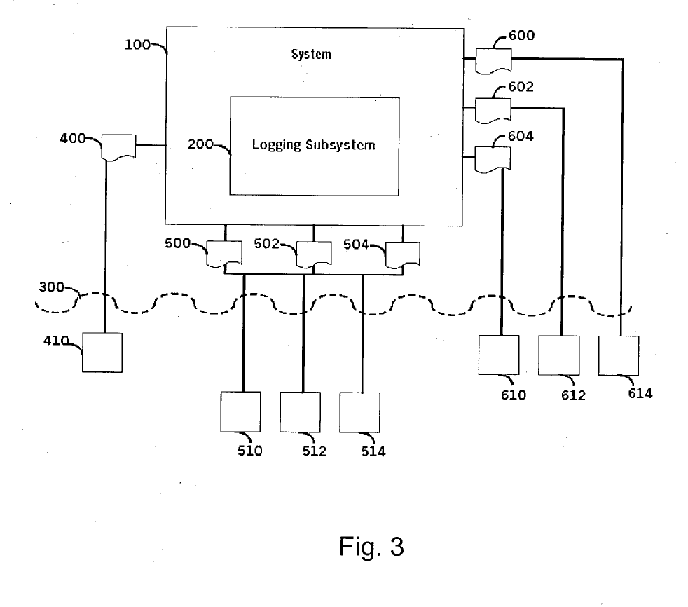

Referring to FIG. 3, a diagram illustrating the basic architecture of a logging system in accordance with one embodiment of the invention is shown. As depicted in this figure, logging subsystem 200 is implemented within transaction system 100. As transactions occur in transaction system 100, they are monitored by logging system 200. When a loggable transaction is detected, logging subsystem 200 determines whether the transaction is within the sets of log messages requested by any of the subscribing clients (410, 510, 512, 514, 610, 612, 614). If not, no log message is generated. If so, a log message corresponding to the transaction is generated and transmitted over a network abstraction layer 300 to the requesting client. Network abstraction layer 300 essentially comprises a network path between the logging system and the clients.

A single client 410 can subscribe to all or some subset 400 of the log messages. A group of clients (510, 512, 514) can jointly subscribe to the same subsets of the logs (500, 502, 504) and deal with them separately, achieving high levels of redundancy against failure of any one of the clients' processes. Another group of clients (610, 612, 614) can jointly subscribe to different subsets of the logs (600, 602, 604). Each of these clients deals with its own subset in the same way as the others. In this manner, no one client has to deal with all of the logging information by itself, and high levels of performance can be achieved, and none of the clients are overwhelmed.

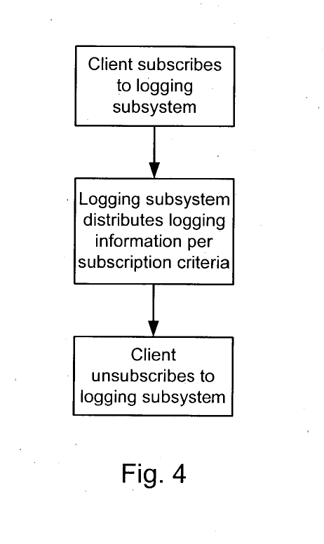

Referring to FIG. 4, a flow diagram illustrating a method in accordance with one embodiment of the invention is shown. In this embodiment, one or more clients may subscribe to the logging subsystem to in order to obtain logging information. Thus, in the first step of the method, the client subscribes to the logging subsystem. The client's subscription to the logging subsystem defines the transactions for which logging information is to be distributed to the client, as well as the form of the logging information. After the client's subscription is implemented by the logging subsystem, each of the transactions monitored by the logging subsystem is filtered by the client's subscription criteria. If any particular transaction meets these criteria, a log message for that transaction is generated for distribution to the client. The client's subscription may define the level of detail included in the log message. For example, the log message may only indicate that a particular transaction occurred, or it may indicate additional information, such as the time of the transaction or the like. If it is no longer necessary for the client to receive the logging information, the client may unsubscribe to the logging subsystem.

In one embodiment, the transaction system to which the logging subsystem is coupled comprises a network server. An exemplary network server is described in detail in U.S. patent application No. ______ (Attorney Docket No. IDET1130-1), by Jeremy S. de Bonet, Todd A. Stiers, and Phillip Alvelda VII, filed on Jan. 14, 2003 and entitled entitled “Method And System Of Performing Transactions Using Shared Resources And Different Applications,” which is which is incorporated by reference as if set forth herein in its entirety.

The network server implements the logging subsystem as well as the transaction system. The network server accepts connections from clients of the logging subsystem and filters the logging information according to the subscriptions of the respective clients. Accordingly, the network server is configured to accept subscription information, including the criteria with which transactions or logging information will be filtered for distribution to client. These criteria may be specified using regular expressions, numerical comparisons, string matches, or other means for filtering the logging information. The network server is also configured to maintain information on the correspondence of clients, filtering criteria and connections, so that the desired logging information can be distributed to each of the clients.

The network server may accepts connections from a plurality of clients. Each of these clients may specify its own subscription criteria. Based upon the respective subscription criteria, the network server may distribute to the clients identical sets of logging information, overlapping but non-identical sets of information, exclusive sets of information, or any combination thereof. The system thereby enables such features as redundant logging and load balancing through the selection of appropriate subscription criteria for each of the clients.

In one embodiment, the logging clients can dynamically subscribe and unsubscribe to the logging subsystem. While the logging subsystem operates continuously, monitoring transactions and processing these transactions according to the client subscriptions, the client subscriptions themselves may change. When the logging subsystem begins operation, there may be no clients subscribed to it. After the logging subsystem is operational, two clients may be subscribed, for example, to each receive half of the logging information (thereby providing load balancing between the two clients). Later, it may be desirable to load balance between three clients, so the first two clients may be unsubscribed and then re-subscribed to receive one third of the logging information. The third client would also be subscribed to receive one third of the logging information. Alternatively, the system may make provisions for modifying the subscription criteria without necessarily having to unsubscribe.

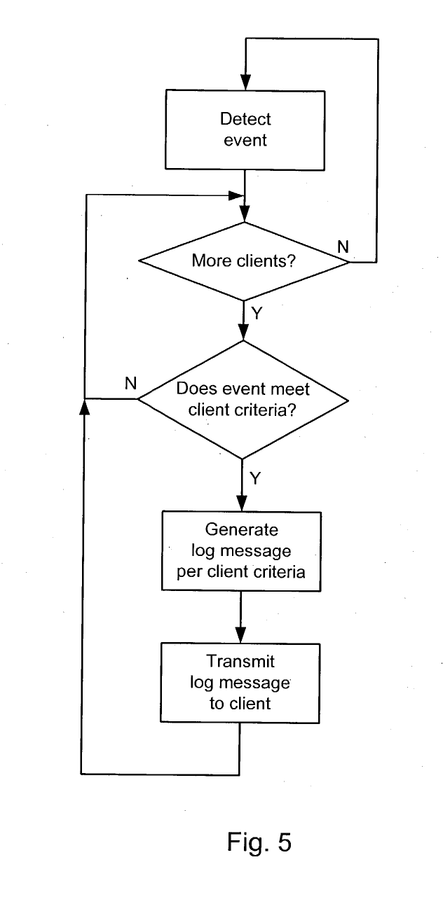

Referring to FIG. 5, a flow diagram illustrating a method in accordance with one embodiment is shown. In this embodiment, the method is implemented within the logging subsystem. The method essentially comprises detecting an event for which logging information can be generated, then, for each of the clients, determining whether the client desires logging information for the event and, if so, generating the appropriate log message and transmitting the log message to the client.

In this embodiment, the method is implemented on a event-by-event basis. That is, as each event occurs in the system, the logging subsystem detects the event and begins to determine how to distribute log information for that event. First, the logging subsystem determines whether any logging clients are subscribed. If there are no subscribed clients, then no logging information is generated or distributed. If there are clients that are subscribed to the logging subsystem, the event is processed for each of the clients, one by one.

For each of the subscribed clients, the event is first compared to the subscription criteria corresponding to the client. If, for a given client, the event matches that criteria specified for that client, a log message corresponding to the event will be generated. Thus, the logging information is filtered according to the clients' subscription criteria. The logging subsystem formats the log message according to the requirements of that particular client's subscription. The resulting log message is then transmitted to that client. This is repeated for each of the subscribed clients.

As indicated above, the methods of the present invention can be implemented, as an exemplary embodiment, in a network proxy server. In such embodiment, clients may communicate with the logging subsystem via an Internet protocol. HTTP (hypertext transfer protocol) is preferably used, but other protocols may be used as well.

While the embodiments of the invention described herein focus primarily upon network-based implementations, it is not necessarily the case that the logging subsystem and its clients be separated by a network. In one alternative embodiment, the logging subsystem and clients may each be components of the system that is being logged. In yet another alternative, some of the clients may be components of the system, while other clients may be resident in systems that are independent of the system. Many other variations are also possible.

The embodiments of the invention described above “pull” information from the logging subsystem. That is, the logging subsystem provides logging information to clients in response to requests for the information. For example, a client subscribes to the logging subsystem (i.e., requests logging information), and the logging subsystem provides information to the client responsive to the subscription (request). In some embodiments, a client's subscription to the logging subsystem may be considered a standing request to pull information from the subsystem, while in other embodiments a client may make individual requests for logging information. While this particular feature (the pulling of the logging information) is distinct from prior art systems which “push” information from the logging subsystem to the corresponding destination, it should be noted that some embodiments of the invention may be configured to push logging information to the clients. For example, one embodiment may be configured to filter the logging information and distribute it to a plurality of clients irrespective of requests by the clients. In one such embodiment, the logging subsystem may be configured to load-balance among all the available clients by simply distributing information for every nth event to each of the clients (where it is assumed that there are n clients, and the subsets of logging information are offset so that they are exclusive).

While it is contemplated that embodiments of the present invention may enable clients to avoid being overwhelmed by too much logging information, it is possible that a given client may have difficulty keeping up with the amount of information that is distributed to it. It may therefore be desirable to implement a buffer to store the logging information until it can be accepted by the client. In one embodiment, the buffer may be implemented in the logging subsystem. The buffer may queue logging information for a corresponding client said that it can be delivered after a configurable delay. Such a buffer may also be used to accumulate logging information so that it can be transmitted to the client in bulk, rather than in small pieces, thereby reducing overhead.

In some embodiments of the invention, without logging subsystem may be configured to provide unique identifiers for logging information that is transmitted to the clients. This may be particularly useful in the case of systems that are configured to perform load balancing. The use of unique identifiers may enable duplicative information to be eliminated when the subsets of logging information transmitted to different clients are combined.

The various embodiments of the present invention may provide a number of advantages over prior art logging systems. As mentioned above, prior art systems merely identified event s and dumped all of the corresponding logging information to a single location. It was not unusual in such a system for the destination device to be overwhelmed by the huge amounts of data that were transmitted to it. Trying to capture all of this information in a single destination device was analogous to trying to take a drink from a fire hose—some portion of it was typically lost. These logging systems were therefore typically somewhat unreliable and had lower performance than was desired. The various embodiments of the present invention may provide the ability to achieve arbitrarily high levels of reliability and performance without having to change the underlying logging subsystem. This is done primarily through the ability to perform load balancing and redundant logging enough information.

In one environment, the present logging subsystem may be configured to distribute the same logging information to multiple clients. This may be achieved by having each of these clients subscribe to the same subset of logging information. This redundant collection of information minimizes the probability that information will be lost as a result of failures within the system. For example, if one of the clients experiences a failure and loses some of the logging information, it is very likely that one of the other clients did not experience a failure and therefore captured the information that was lost by the other client. By increasing the number of clients receiving redundant information, the reliability of the overall system can be increased to an arbitrary level (e.g., 99.9999% reliability).

In one environment, the present logging subsystem may be configured to separate the logging information into exclusive subsets, and to deliver each of the subsets to a different client. In this manner, the system can perform load balancing among the clients. By balancing the load (i.e., distributing the logging information) among the clients, the likelihood that anyone of the clients will be overwhelmed by the received information is reduced. Again, this results in a lower likelihood of failures and/or data loss, which in turn results in higher reliability. The reduced load also allows each of the clients to operate at a higher level of performance. The logging subsystem itself may also have improved performance, as it need not be concerned with the ability of the clients to keep up with the logging information.

It should be noted that, in addition to increasing the reliability and performance of the system through redundancy and the load balancing, the present invention may reduce the bandwidth requirements associated with transmissions of the logging information over a network connection by filtering the information distributed to each client. Because each client receives only information which meets the criteria specified for that client, the network connection between this client and the logging subsystem will have reduced bandwidth requirements, compared to the transmission of all of the logging information to a single destination, as performed in the prior art. Even if all of the logging information is distributed, it will typically be distributed to multiple clients, so the loading on the network connection to any one of these clients will be less than if all of the information were transmitted to a single client. It may therefore be possible to eliminate the problem of a network bottleneck, as encountered in the prior art.

That filtering of the logging information is useful, not only in the context of redundancy and the load balancing, but also in the context of eliminating unwanted data. Although, in some instances, it is desirable to log every event (e.g., billable transactions), it is often the case that a portion of the logging information is not needed. For example, a system may be configured to log certain types of event s in case this information is ever needed, but it is not necessary to have this information all the time. This information may be useful for diagnostic purposes, but may be unnecessary if the system is operating properly. Embodiments of the present invention may allow clients to request certain types of logging information that is useful at the time, while discarding other logging information that is not currently necessary. Similarly, the client may select a level of detail for the lo information, as some details may be useful at some times, but not others. This avoids the problems of collecting and storing the unnecessary information, as well as the problem of sorting through the logging information to identify the portion that is useful and the portion that is not. This may substantially increase the performance of the system.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms ‘comprises,’ ‘comprising,’ or any other variations thereof, are intended to be interpreted as non-exclusively including the elements or limitations which follow those terms.

Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications additions and improvements to the embodiments described above are possible. It is contemplated that these variations, modifications, additions and improvements fall within the scope of the invention as detailed within the following claims.

What is claimed is:

1. A system comprising:
a logging subsystem;
wherein the logging subsystem is configured to monitor event s;
wherein the logging subsystem is configured to filter the event s according to criteria corresponding to one or more clients; and
wherein the logging subsystem is configured to forward logging information for the filtered event s to the one or more clients according to the criteria.

2. The system of claim 1, further comprising:
a network proxy server, wherein the logging subsystem comprises a component of the network proxy server and is configured to monitor event s of the network proxy server;
a network coupled to the network proxy server; and
the one or more clients, wherein the clients are coupled to the network, wherein each of the clients has an associated set of the criteria and wherein for each of the clients the logging ss is configured to filter the event s according to the set of the criteria associated with client and to forward the resulting logging information to the client.

3. The system of claim 1, wherein the logging ss is configured to provide logging information to clients in response to corresponding requests for logging information.

4. The system of claim 1, wherein the logging ss is configured to push logging information to clients.

5. The system of claim 1, further comprising a network proxy server, wherein the logging system is coupled to the network proxy server to monitor event s in the network proxy server.

6. The system of claim 5, wherein the logging ss comprises a component of the network proxy server.

7. The system of claim 1, wherein the logging subsystem is configured to forward logging information to each client at a level of detail specified by the client.

8. The system of claim 1, wherein the logging subsystem is configured to filter logging information for each client using criteria specified in the by the client.

9. The system of claim 8, wherein two or more of the clients specify identical criteria for filtering the logging information and the logging ss delivers redundant subsets of logging information to the two clients based on the identical criteria.

10. The system of claim 8, wherein two or more of the clients specify criteria for filtering the logging information wherein the criteria define exclusive subsets of the logging information and the logging ss delivers load-balancing subsets of logging information to the two clients based on the criteria.

11. The system of claim 8, wherein at least one of the clients specifies criteria for filtering the logging information wherein the criteria specify a subset of available types of event s.

12. The system of claim 8, wherein at least one of the clients specifies criteria for filtering the logging information wherein the criteria specify every nth event.

13. The system of claim 1, wherein the logging server is configured to dynamically implement subscription requests and unsubscribe requests from clients.

14. The system of claim 1, further comprising the clients and a network coupled between the logging subsystem and the clients, wherein the logging subsystem is configured to receive subscription requests from the clients via network connections and to forward logging information to the one or more clients via network connections.

15. A method for logging event s comprising:
for each of one or more clients, providing a corresponding set of criteria; and
for each of a plurality of event s,
detecting the event and
for each of the one or more clients,
determining whether the event meets the set of criteria corresponding to the client, and
if the event meets the set of criteria, forwarding log information for the event to the client.

16. The method of claim 15, wherein the method is implemented in a network proxy server coupled to the one or more clients via a network and wherein forwarding log information comprises transmitting the log information to the corresponding client via the network.

17. The method of claim 15, wherein forwarding log information comprises pushing the log information to the corresponding client.

18. The method of claim 15, wherein forwarding log information comprises transmitting the log information to the corresponding client in response to a request for the log information.

19. The method of claim 15, wherein the set of criteria corresponding to a first client identifies a level of detail of the log information to be forwarded to the first client.

20. The method of claim 15, wherein the one or more clients comprise a first plurality of clients, wherein the sets of criteria corresponding to the first plurality of clients are identical, and wherein the log information transmitted to each of the first plurality of clients is redundant.

21. The method of claim 15, wherein the one or more clients comprise a first plurality of clients, and wherein the sets of criteria corresponding to the first plurality of clients define exclusive subsets of the logging information, and wherein the log information transmitted to each of the first plurality of clients is a load-balancing subset of the log information.

22. The method of claim 15, wherein the set of criteria corresponding to a first client identifies a selected type of event s.

23. The method of claim 15, wherein the set of criteria corresponding to a first client identifies every nth event.

24. The method of claim 15, wherein providing the sets of criteria corresponding to the one or more clients comprises accepting subscription requests from the clients, wherein the subscription requests contain the sets of criteria corresponding to the clients.

25. The method of claim 24, further comprising dynamically subscribing or unsubscribing one or more clients to the logging ss.

26. The method of claim 15, wherein the set of criteria corresponding to a first client identifies all of the event s.

27. The method of claim 15, wherein the set of criteria corresponding to a first client identifies a subset of the event s comprising less than all of the event s.

28. A software product comprising a plurality of instructions embodied in a medium readable by a data processor, wherein the instructions are configured to cause the data processor to perform the method comprising:
for each of one or more clients, maintaining a corresponding set of criteria; and
for each of a plurality of event s,
detecting the event and
for each of the one or more clients,
determining whether the event meets the set of criteria corresponding to the client, and
if the event meets the set of criteria, forwarding log information for the event to the client.

29. The software product of claim 28, wherein the instructions are configured to cause the data processor to monitor event s in a network proxy server, to receive the sets of criteria from the clients via a network connection, and to transmit the log information to the corresponding clients via the network connection.
